(19) United States
(12) Patent Application Publication
(10) Pub. No.: US 2017/0179544 A1
(43) Pub. Date: Jun. 22, 2017

(54) LITHIUM POSITIVE ELECTRODE MATERIAL AND LITHIUM BATTERY

(71) Applicant: INDUSTRIAL TECHNOLOGY RESEARCH INSTITUTE, Hsinchu (TW)

(72) Inventors: Hsiu-Fen LIN, Taichung City (TW); Shih-Chieh LIAO, Taoyuan City (TW); Chia-Chin LEE, Yuanchang Township (TW); Chi-Ju CHENG, Zhudong Township (TW); Jin-Ming CHEN, Taoyuan City (TW)

(73) Assignee: INDUSTRIAL TECHNOLOGY RESEARCH INSTITUTE, Hsinchu (TW)

(21) Appl. No.: 15/347,377

(22) Filed: Nov. 9, 2016

(30) Foreign Application Priority Data
Dec. 22, 2015 (TW) 104143090

(51) Int. Cl. H01M 10/42; H01M 4/36; H01M 4/62; H01M 4/04; H01M 4/505; H01M 4/525

(52) U.S. Cl. CPC H01M 10/4235; H01M 4/505; H01M 4/525; H01M 4/625; H01M 4/0471; H01M 4/362; H01M 4/623; H01M 2004/028

(57) ABSTRACT

A lithium positive electrode material is provided, which includes a host material and a doping material doped into the host material, wherein the doping material has a chemical formula of Li_{y}La_{z}Zr_{w}AlᵤO_{12+(u*3/2)}, wherein 5≦y≦8, 2≦z≦5, 1≦w≦3, and 0<u<1. The lithium positive electrode material may collocate with carbon material and binder to form a positive electrode for a lithium battery.

### CROSS REFERENCE TO RELATED APPLICATIONS

The present application is based on, and claims priority from, Taiwan Application Ser. No. 104143090, filed on Dec. 22, 2015, the disclosure of which is hereby incorporated by reference herein in its entirety.

### TECHNICAL FIELD

The technical field relates to a lithium battery, and it relates to a lithium positive electrode material of the lithium battery.

### BACKGROUND

Much research regarding batteries as a driving energy source has been conducted to minimize the amount or volume of batteries for, and meet the sophisticated technological requirements of, portable electronic devices such as video cameras, cellular phones and laptop computers. In Particular, rechargeable lithium batteries have more energy density per unit weight; around 3 times that of the conventional lead storage batteries such as nickel-cadmium batteries, nickel-hydro batteries and nickel-zinc batteries. In addition, rechargeable lithium batteries can be recharged relatively quickly.

For a higher energy density in the lithium battery, a solid solution formed of Li₂MnO₃ and a layered material LiMO₂ (M is Ni, Co, Mn, Fe, Cr, or a combination thereof) is used as a positive electrode material with high energy. Although the lithium-rich positive electrode material with high capacity has a higher first charge capacity, its discharge capacity will be reduced by a faster discharge rate (e.g. higher discharge current).

Accordingly, a novel lithium positive electrode material is called for overcoming the above shortcomings.

### SUMMARY

One embodiment of the disclosure provides a lithium positive electrode material, comprising: a host material; and a doping material doped into the host material, wherein the doping material has a chemical formula of Li_{y}La_{z}Zr_{w}AlᵤO_{12+(u*3/2)}, wherein 5≦y≦8; 2≦z≦5; 1≦w≦3; and 0<u<1.

One embodiment of the disclosure provides a lithium battery, comprising: a positive electrode including 100 parts by weight of a lithium positive electrode material, 5 to 20 parts by weight of a carbon material, and 8 to 20 parts by weight of a binder; a negative electrode; a separator film disposed between the positive electrode and the negative electrode to define a reservoir region; an electrolyte solution in the reservoir region; and a sealant structure wrapping around the positive electrode, the negative electrode, the separator film, and the electrolyte solution, wherein the lithium positive electrode material comprises a host material and a doping material doped into the host material, wherein the doping material has a chemical formula of Li_{y}La_{z}Zr_{w}AlᵤO_{12+(u*3/2)}, wherein 5<y<8; 2<z<5; 1<w<3; and 0<u<1.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 shows a lithium battery in one embodiment of the disclosure.

FIG. 2 shows curves of voltage versus capacitance corresponding to different charge-discharge currents of an electrode in one Example of the disclosure.

FIG. 3 shows curves of voltage versus capacitance corresponding to different charge-discharge currents of an electrode in one Example of the disclosure.

FIG. 4 shows curves of voltage versus capacitance corresponding to different charge-discharge currents of an electrode in one Comparative Example of the disclosure.

FIG. 5 shows curves of voltage versus capacitance corresponding to different charge-discharge currents of an electrode in one Comparative Example of the disclosure.

FIG. 6 shows curves of voltage versus capacitance corresponding to different charge-discharge currents of an electrode in one Comparative Example of the disclosure.

FIG. 7 shows curves of voltage versus capacitance corresponding to different charge-discharge currents of an electrode in one Comparative Example of the disclosure.

FIG. 8 shows curves of voltage versus capacitance corresponding to different charge-discharge currents of an electrode in one Comparative Example of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are shown schematically in order to simplify the drawing.

One embodiment provides a lithium positive electrode material, including a host material and a doping material doped into the host material. The doping material has a chemical formula of Li_{y}La_{z}Zr_{w}AlᵤO_{12+(u*3/2)}, wherein 5≦y≦8; 2≦z≦5; 1≦w≦3; and 0<u<1. If the ratio of Li, La, Zr, or Al is beyond the above range, the impedance of the electrode will be increased to degrade the electrochemical properties of the electrode. The host material has a chemical formula of xLi [Li _{1/3}Mn_{2/3}]O₂-(1−x)Li[Ni_{α-α′}Co_{β-β}, Mn_{γ-γ}, M_{(α′+β′+γ′+δ)}]O_{2+[(α′+β′+γ′+δ)*v/2]}, wherein 0<x<1; 0.3≦α≦0.8; 0.1≦β≦0.4; 0.1≦γ≦0.4; 0≦α′≦0.2; 0≦β′≦0.2; 0≦γ′≦0.2; 0≦δ≦0.2; 0<α′+γ′+δ≦0.2; α+β+γ=1; M is Ta, V, Mg, Ce, Fe, Mo, Sb, Ru, Cr, Ti, Zr, or Sn; and v is a valance number of M. In one embodiment, the doping material occupies the host material with a weight ratio of greater than 0 and less than 10 wt %. Too much doping material may increase the impedance of the electrode and degrade the electrochemical properties of the electrode.

In one embodiment, lithium salt (e.g. lithium hydroxide, lithium carbonate, lithium nitrate, lithium sulfate, or lithium oxalate) or lithium oxide, lanthanum salt (e.g. lanthanum hydroxide, lanthanum acetate, lanthanum carbonate, lanthanum nitrate, lanthanum sulfate, or lanthanum chloride) or lanthanum oxide, zirconium salt (e.g. zirconium hydroxide, zirconium carbonate, zirconium nitrate, zirconium sulfate, or zirconium chloride) or zirconium oxide, and aluminum salt (e.g. aluminum hydroxide, aluminum acetate, aluminum carbonate, aluminum nitrate, aluminum sulfate, or aluminum chloride) or aluminum oxide are stoichiometrically weighed and mixed for 24 hours, and then heated to 900° C. to 1300° C. to be sintered for 4 to 24 hours, thereby forming Li_{y}La_{z}Zr_{w}AlᵤO_{12+(u*3/2)} as the doping material.

The host material and the doping material are mixed and then heated to 700° C. to 1000° C. for 2 to 24 hours to dope the doping material into the host material, thereby forming the lithium positive electrode material.

100 parts by weight of the lithium positive electrode material, 0.1 to 20 parts by weight of a carbon material, 1 to 20 parts by weight of a binder, and 10 to 70 parts by weight of a solvent are mixed to form a paste. The paste is then coated on a metal foil such as aluminum foil, copper foil, or titanium foil. The paste is then baked to dry to remove the solvent thereof, and then laminated to form a positive electrode. In one embodiment, the carbon material can be carbon powder, graphite, hard carbon, soft carbon, carbon fiber, carbon nanotube, or a combination thereof. Too little carbon material makes a positive electrode have an overly low conductivity. Too much carbon material will decrease the active material ratio and therefore reduce the capacitance of the positive electrode. In one embodiment, the binder can be polyvinylidene fluoride, styrene-butadiene rubber, polyamide, or melamine resin. An overly low ratio of the binder results in a low adhesion between the active material and an electrode plate, which causes peeling. An overly high ratio of the binder may increase the impedance of the positive electrode. In one embodiment, the solvent can be N-methyl-2-pyrrolidone (NMP), methyl isobutyl ketone, methyl ether ketone, acetone, methyl ethyl ketone, toluene, xylene, mesitylene, fluorotoluene, difluorotoluene, trifluorotoluene, N,N-dimethylacetamide (DMAc), or a combination thereof.

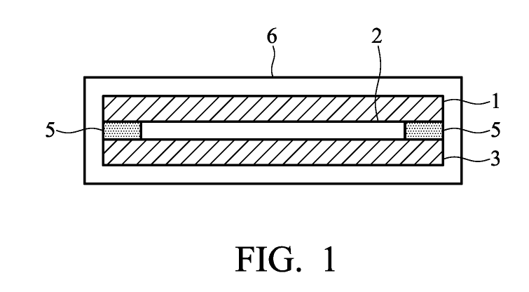

The positive electrode can be utilized to, but be not limited to, a lithium battery as shown in FIG. 1. In FIG. 1, a separator film is disposed between a positive electrode 1 and a negative electrode 3 to define a reservoir region 2 to contain an electrolyte solution. In addition, a sealant structure 6 is disposed outside the above structure to wrap the positive electrode 1, the negative electrode 3, the separator film 5, and the electrolyte solution.

In one embodiment, the negative electrode 3 includes carbon material and lithium alloy. The carbon material can be carbon powder, graphite, carbon fiber, carbon nanotube, or a combination thereof. In one embodiment, the carbon material is carbon powder with a diameter of 5 nm to 30 μm. The lithium alloy can be LiAl, LiZn, Li₃Bi, Li₃Cd, Li₃Sb, Li₄Si, Li_{4.4}Pb, Li_{4.4}Sn, LiC₆, Li₃FeN₂, Li_{2.6}Co_{0.4}N, Li_{2.6}Cu_{0.4}N, or a combination thereof. In addition, the negative electrode 3 may further includes metal oxide such as SnO, SnO₂, GeO, GeO₂, In₂O, In₂O₃, PbO, PbO₂, Pb₂O₃, Pb₃O₄, Ag₂O, AgO, Ag₂O₃, Sb₂O₃, Sb₂O₄, Sb₂O₅, SiO, ZnO, CoO, NiO, FeO, or a combination thereof. Furthermore, the negative electrode 3 may include a polymer binder to enhance the mechanical properties of the negative electrode. The suitable polymer binder can be polyvinylidene fluoride (PVDF), styrene-butadiene rubber (SBR), polyamide, melamine resin, or a combination thereof

The separator film 5 is an insulation material such as polyethylene (PE), polypropylene (PP), or a multi-layered structure (e.g. PE/PP/PE). The electrolyte solution is mainly composed of organic solvent, lithium salt, and additive. The organic solvent can be γ-butyrolactone (GBL), ethylene carbonate (EC), propylene carbonate (PC), diethyl carbonate (DEC), propyl acetate (PA), dimethyl carbonate (DMC), ethylmethyl carbonate (EMC), or a combination thereof. The lithium salt can be LiPF₆, LiBF₄, LiAsF₆, LiSbF₆, LiClO₄, LiAlCl₄, LiGaCl₄, LiNO₃, LiC(SO₂CF₃)₃, LiN(SO₂CF₃)₂, LiSCN, LiO₃SCF₂CF₃, LiC₆F₅SO₃, LiO₂CCF₃, LiSO₃F, LiB(C₆H₅)₄, LiCF₃SO₃, or a combination thereof. The additive can be vinylene carbonate (VC) or another common additive.

Because the positive electrode including the doping material of the disclosure has a higher initial capacitance and a higher capacitance after being discharged by a higher discharge current, a lithium battery applying the positive electrode also has a higher performance.

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

### Example 1

Li(Li_{10/75}Ni_{18/75}Co_{9/75}Mn_{38/75})O₂ was prepared according to Journal of The Electrochemical Society, 157, 4, A447-A452 (2010) to serve as a host material.

Lithium salt, lanthanum salt, zirconium salt, and aluminum salt were stoichiometrically weighed and mixed for 24 hours, and then heated to 1200° C. to be sintered for 10 hours, thereby forming Li₇La₃Zr₂Al_{0.07}O_{12.0105} to serve as a doping material.

100 parts of the host material and 2 parts by weight of the doping material were mixed, and then heated to 900° C. to be sintered for 20 hours, such that the doping material was doped into the host material to form a lithium positive electrode material.

80 parts of the lithium positive electrode material, 10 parts by weight of a carbon material (KS4, commercially available from IMERYS), 10 parts by weight of a binder (PVDF, commercially available from Kureha), and 50 parts by weight of a solvent NMP were mixed to form a paste. The paste was then coated on a aluminum foil, then baked to dry to remove the solvent, and then laminated to form a positive electrode.

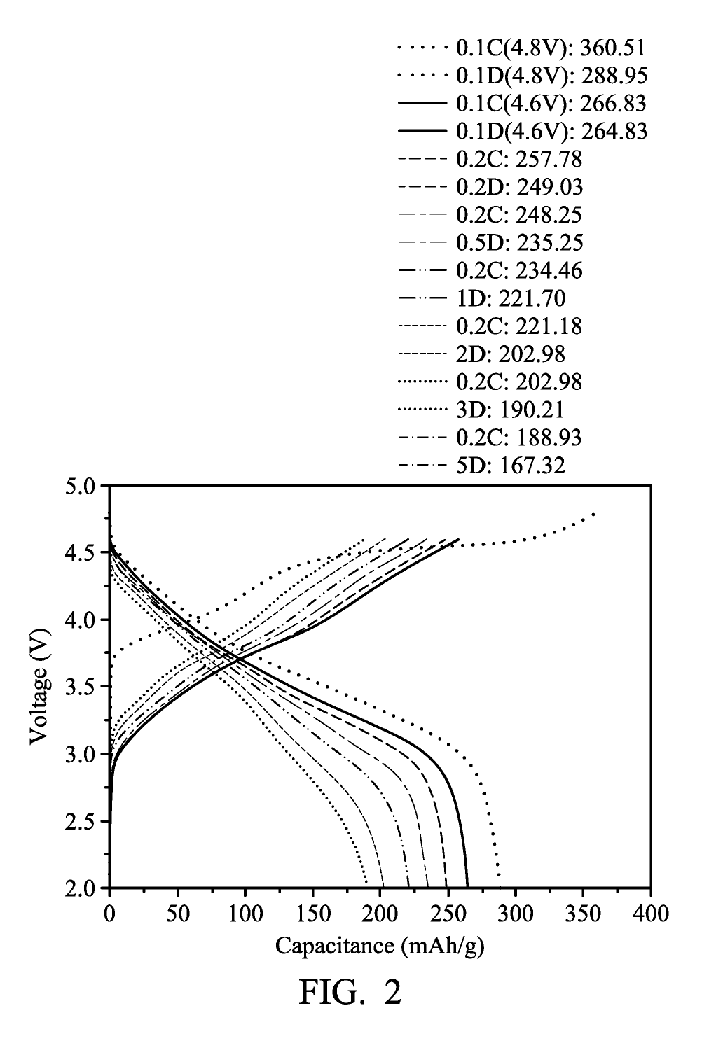

The positive electrode was put into an electrolyte solution (0.1 M LiPF₆ in EC/DMC). The positive electrode was charged by a current density of 20 mA/g (0.1 C) or 40 mA/g (0.2 C), and discharged by a current density of 20 mA/g (0.1 C), 40 mA/g (0.2 C), 100 mA/g (0.5 C), 200 mA/g (1 C), 400 mA/g (2 C), 600 mA/g (3 C), or 1000 mA/g (5 C). The charge-discharge experiments were performed at a voltage of 2 to 4.6V (V versus Li/Li⁺) and a temperature of room temperature (25° C.) to obtain curves of voltage versus capacitance (mAh/g) of the positive electrode corresponding to different charge-discharge currents, as shown in FIG. 2 and Table 1.

### Example 2

Lithium salt, lanthanum salt, zirconium salt, and aluminum salt were stoichiometrically weighed and mixed for 24 hours, and then heated to 1200° C. to be sintered for 10 hours, thereby forming Li₇La₃Zr₂A_{0.15}O₁₂ to serve as a doping material.

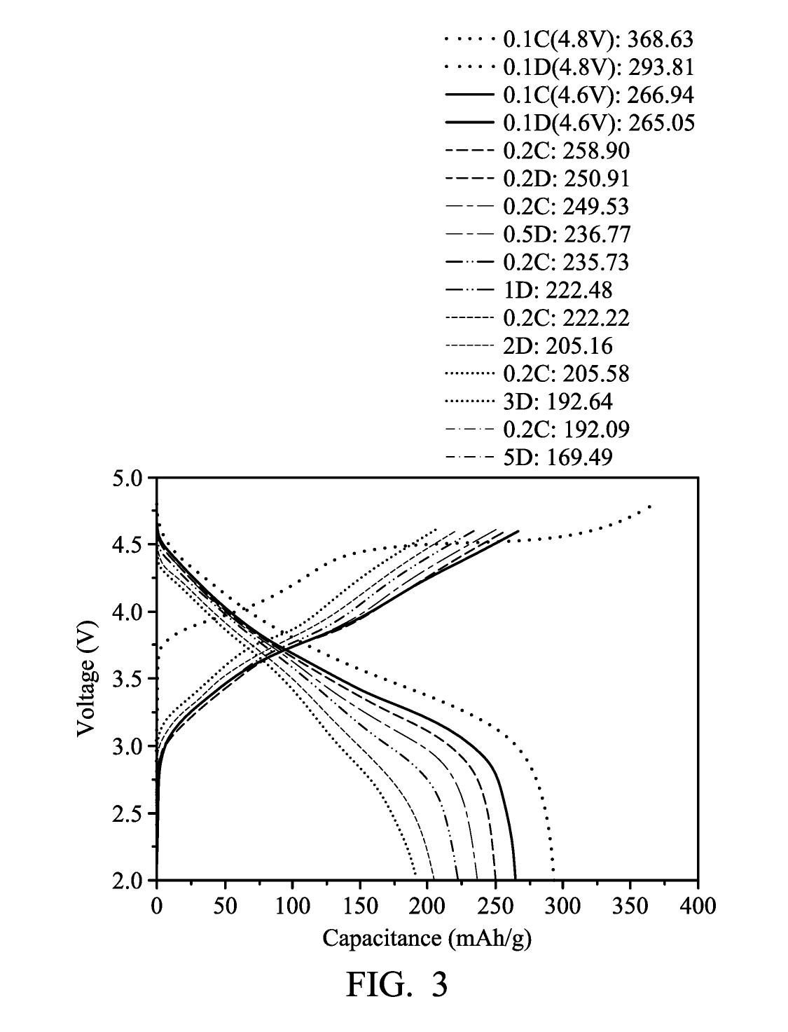

Example 2 was similar to Example 1, with the difference being that the doping material composition was replaced with Li₇La₃Zr₂A_{0.15}O₁₂. The composition of the host material, the ratio of the host material and the doping material, the amounts of the lithium positive electrode material, the carbon material, the binder, and the solvent in the paste, the process factors of manufacturing the positive electrode, and the charge-discharge experiment factors in Example 2 were similar to that in Example 1. Curves of voltage versus capacitance (mAh/g) of the positive electrode corresponding to different charge-discharge currents are shown in FIG. 3 and Table 1.

### Comparative Example 1

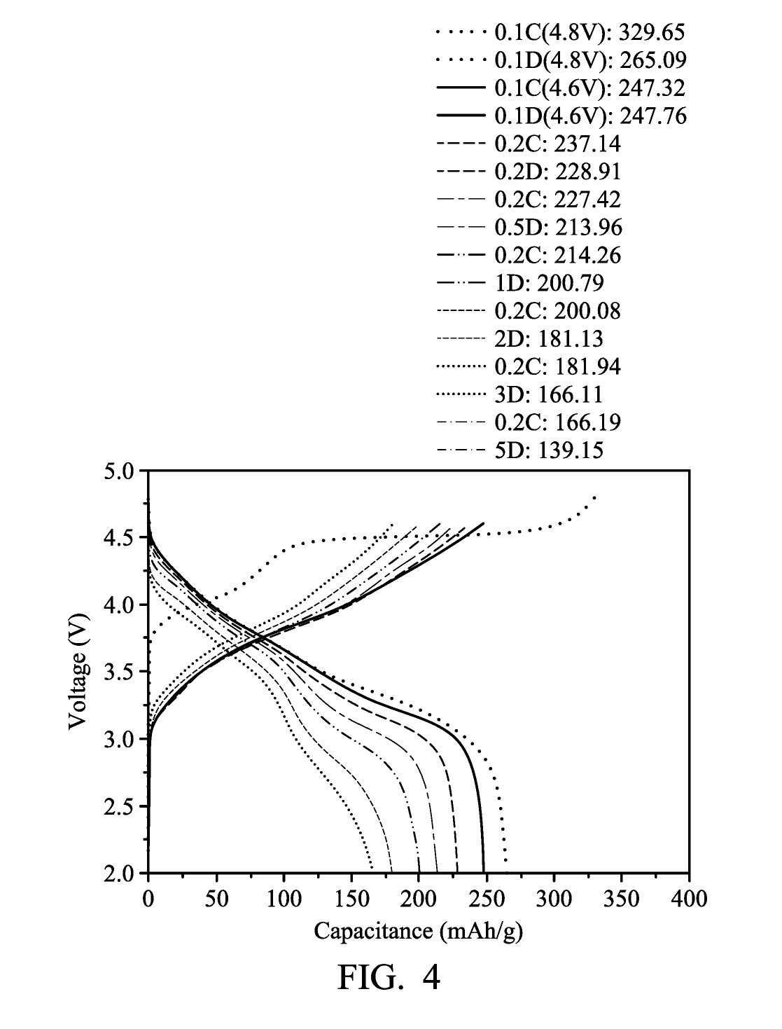

Comparative Example 1 was similar to Example 1, with the difference being that the lithium positive electrode material only included the host material without any doping material. The composition of the host material, the amounts of the lithium positive electrode material, the carbon material, the binder, and the solvent in the paste, the process factors of manufacturing the positive electrode, and the charge-discharge experiment factors in Comparative Example 1 were similar to that in Example 1. Curves of voltage versus capacitance (mAh/g) of the positive electrode corresponding to different charge-discharge currents are shown in FIG. 4 and Table 1.

TABLE 1

| | | Capacitance of the lithium | | Capacitance of the lithium | | Capacitance of the lithium |
|---|---|---|---|---|---|---|
| | | battery after being discharged | | battery after being discharged | | battery after being discharged |
| | | (The capacitance of the | | (The capacitance of the | | (The capacitance of the |
| Charge- | | lithium battery after being | | lithium battery after being | | lithium battery after being |
| Discharge | Comparative | discharged by 0.1 C was set | Example | discharged by 0.1 C was set | Example | discharged by 0.1 C was set |
| (C) | Example 1 | as 100%) | 1 | as 100%) | 2 | as 100%) |
| 0.1C-0.1D | 247 | 100% | 264 | 100% | 265 | 100% |
| 0.2C-0.2D | 228 | 92.3% | 249 | 94.3% | 250 | 94.3% |
| 0.2C-0.5D | 213 | 86.2% | 235 | 89.0% | 236 | 89.1% |
| 0.2C-1D | 200 | 80.9% | 221 | 83.7% | 222 | 83.8% |
| 0.2C-2D | 181 | 73.2% | 202 | 76.5% | 205 | 77.4% |
| 0.2C-3D | 166 | 67.2% | 190 | 72.0% | 192 | 72.5% |
| 0.2C-5D | 139 | 56.2% | 167 | 63.2% | 169 | 63.8% |

As shown in Table 1, the doping materials in Examples 1 and 2 could efficiently enhance the capacitance of the positive electrode after first charge-discharge. Moreover, the positive electrode in Examples 1 and 2 had a higher capacitance and C-rate effect.

### Comparative Example 2

Lithium salt, lanthanum salt, zirconium salt, and yttrium salt were stoichiometrically weighed and mixed for 24 hours, and then heated to 1200° C. to be sintered for 10 hours, thereby forming Li₇La₃Zr_{1.4}Y_{0.8}O₁₂ to serve as a doping material.

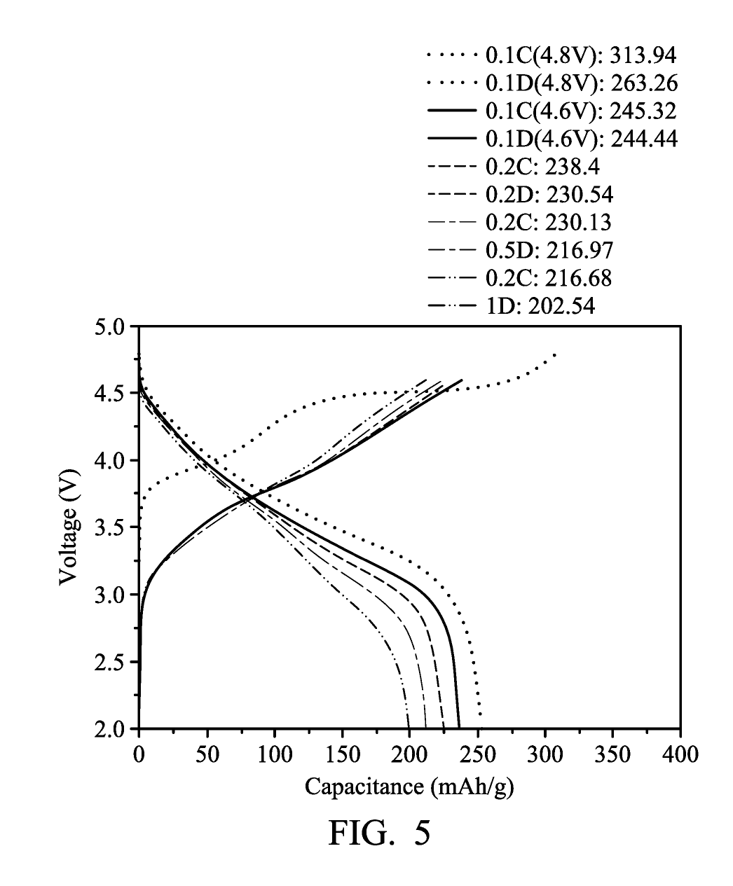

Comparative Example 2 was similar to Example 1, with the difference being that the doping material composition was replaced with Li₇La₃Zr_{1.4}Y_{0.8}O₁₂. The composition of the host material, the ratio of the host material and the doping material, the amounts of the lithium positive electrode material, the carbon material, the binder, and the solvent in the paste, the process factors of manufacturing the positive electrode, and the charge-discharge experiment factors (except the discharge current density was only 20 mA/g (0.1 C) to 200 mA/g (1 C)) in Comparative Example 2 were similar to that in Example 1. Curves of voltage versus capacitance (mAh/g) of the positive electrode corresponding to different charge-discharge currents are shown in FIG. 5 and Table 2.

Comparative Example 3

Lithium salt, lanthanum salt, zirconium salt, and tantalum salt were stoichiometrically weighed and mixed for 24 hours, and then heated to 1200° C. to be sintered for 10 hours, thereby forming Li_{6.75}La₃Zr_{1.75}Ta_{0.25}O₁₂ to serve as a doping material.

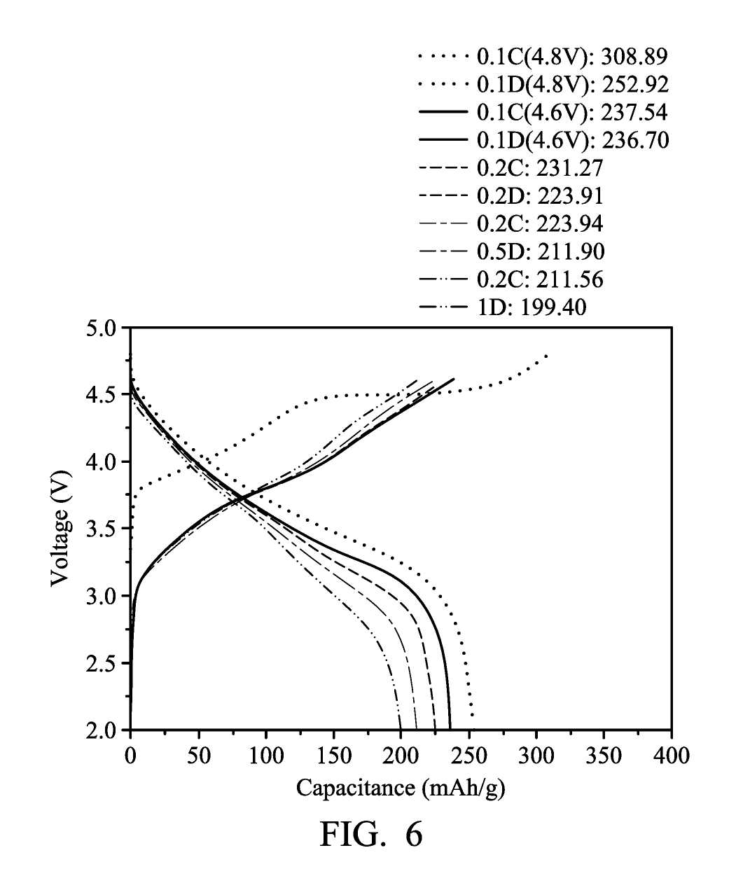

Comparative Example 3 was similar to Example 1, with the difference being that the doping material composition was replaced with Li_{6.75}La₃Zr_{1.75}Ta_{0.25}O₁₂. The composition of the host material, the ratio of the host material and the doping material, the amounts of the lithium positive electrode material, the carbon material, the binder, and the solvent in the paste, the process factors of manufacturing the positive electrode, and the charge-discharge experiment factors (except the discharge current density was only 20 mA/g (0.1 C) to 200 mA/g (1 C)) in Comparative Example 3 were similar to that in Example 1. Curves of voltage versus capacitance (mAh/g) of the positive electrode corresponding to different charge-discharge currents are shown in FIG. 6 and Table 2.

TABLE 2

| Charge-Discharge | | Comparative | Comparative |
|---|---|---|---|
| (C) | Example 2 | Example 2 | Example 3 |
| 0.1C-0.1D | 265 | 244 | 237 |
| 0.2C-0.2D | 250 | 230 | 223 |
| 0.2C-0.5D | 236 | 216 | 211 |
| 0.2C-1D | 222 | 202 | 199 |

Compared to other doping materials, the doping material in Example could further enhance the capacitance and the C-rate effect of the positive electrode, as shown in Table 2.

### Comparative Example 4

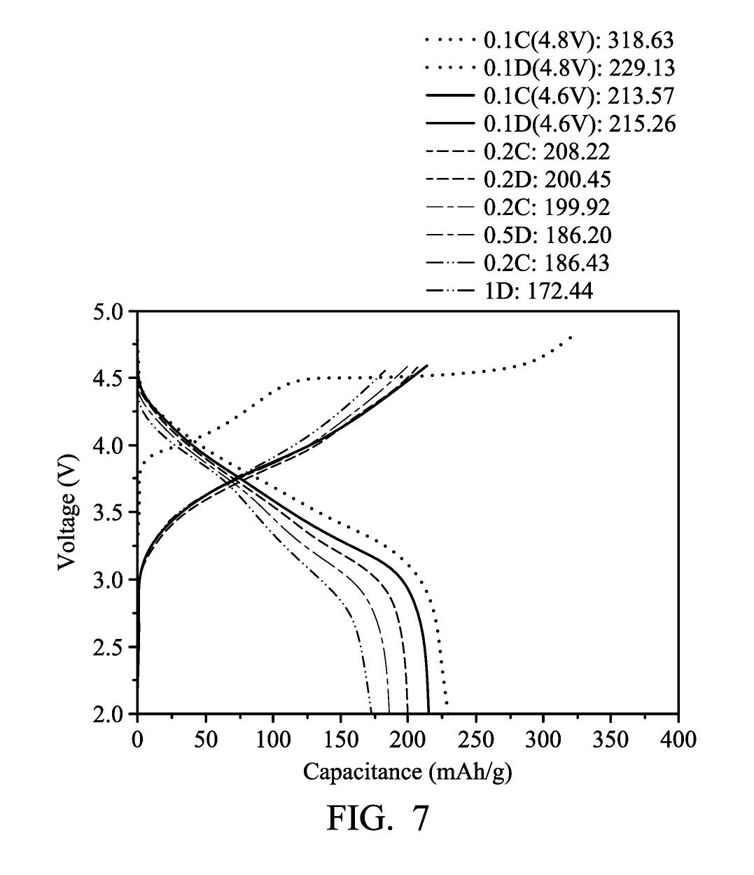

Comparative Example 4 was similar to Example 1, with the differences that the doping material composition was replaced with Al, and the host material and the doping material had a weight ratio of 100:1. The composition of the host material, the amounts of the lithium positive electrode material, the carbon material, the binder, and the solvent in the paste, the process factors of manufacturing the positive electrode, and the charge-discharge experiment factors in Comparative Example 4 (except the discharge current density was only 20 mA/g (0.1 C) to 200 mA/g (1 C)) were similar to that in Example 1. Curves of voltage versus capacitance (mAh/g) of the positive electrode corresponding to different charge-discharge currents are shown in FIG. 7 and Table 3.

### Comparative Example 5

Lithium salt, lanthanum salt, and zirconium salt were stoichiometrically weighed and mixed for 24 hours, and then heated to 1200° C. to be sintered for 10 hours, thereby forming Li₇La₃Zr₂O₁₂ to serve as a doping material.

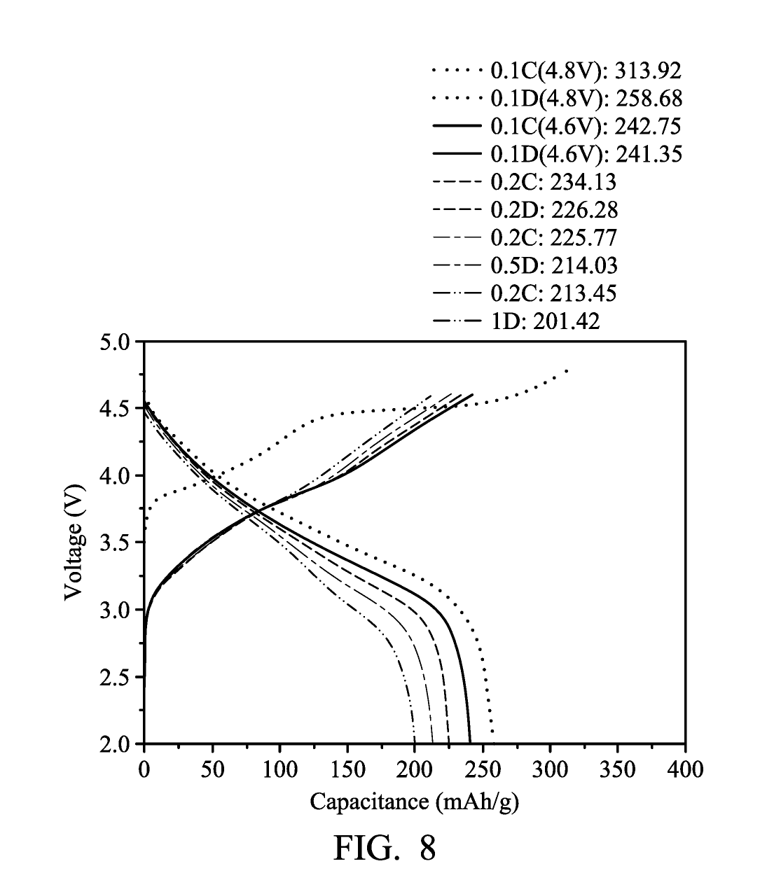

Comparative Example 5 was similar to Example 1, with the difference being that the doping material composition was replaced with Li₇La₃Zr₂O₁₂. The composition of the host material, the ratio of the host material and the doping material, the amounts of the lithium positive electrode material, the carbon material, the binder, and the solvent in the paste, the process factors of manufacturing the positive electrode, and the charge-discharge experiment factors (except the discharge current density was only 20 mA/g (0.1 C) to 200 mA/g (1 C)) in Comparative Example 5 were similar to that in Example 1. Curves of voltage versus capacitance (mAh/g) of the positive electrode corresponding to different charge-discharge currents are shown in FIG. 8 and Table 3.

TABLE 3

| Charge-Discharge | Comparative | | Comparative | Comparative |
|---|---|---|---|---|
| (C) | Example 1 | Example 2 | Example 4 | Example 5 |
| 0.1C-0.1D | 247 | 265 | 215 | 241 |
| 0.2C-0.2D | 228 | 250 | 200 | 226 |
| 0.2C-0.5D | 213 | 236 | 186 | 214 |
| 0.2C-1D | 200 | 222 | 172 | 201 |

Compared to the other doping materials, the doping material in Example could further enhance the capacitance of the positive electrode, as shown in Table 3. Moreover, the positive electrode including the doping material in Example had a higher capacitance and C-rate effect after being discharged by a higher current.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A lithium positive electrode material, comprising:
a host material; and
a doping material doped into the host material,
wherein the doping material has a chemical formula of Li_{y}La_{z}Zr_{w}AlᵤO_{12+(u*3/2)},
wherein 5≦y≦8;
2≦z≦5;
1≦w≦3; and
0<u<1 .

2. The lithium positive electrode material as claimed in claim 1, wherein the host material has a chemical formula of
xLi[Li_{1/3}Mn_{2/3}]O₂-(1−x)Li[Ni_{α-α′}Co_{β-β′}Mn_{γ-γ′}M_{(α′+β′+γ′+δ)}]O_{2+[(α′+β′+γ′+δ)*v/2]},
wherein 0<x<1;
0.3≦α≦0.8;
0.1=β≦0.4;
0.1≦γ≦0.4;
0≦α′≦0.2;
0≦β′≦0.2;
0≦γ′≦0.2;
0≦δ≦0.2;
0<α′+β′+γ′+δ≦0.2;
α+β+γ=1;
M is Ta, V, Mg, Ce, Fe, Mo, Sb, Ru, Cr, Ti, Zr, or Sn; and
v is a valance number of M.

3. The lithium positive electrode material as claimed in claim 1, wherein the doping material occupies the host material with a weight ratio of greater than 0 and less than 10 wt %.

4. A lithium battery, comprising:
a positive electrode including 100 parts by weight of a lithium positive electrode material, 5 to 20 parts by weight of a carbon material, and 8 to 20 parts by weight of a binder;
a negative electrode;
a separator film disposed between the positive electrode and the negative electrode to define a reservoir region;
an electrolyte solution in the reservoir region; and
a sealant structure wrapping around the positive electrode, the negative electrode, the separator film, and the electrolyte solution,
wherein the lithium positive electrode material comprises:
a host material; and
a doping material doped into the host material,
wherein the doping material has a chemical formula of Li_{y}La_{z}Zr_{w}AlᵤO_{12+(u*3/2)},
wherein 5≦y≦8;
2≦z≦5;
1≦w≦3; and
0<u<1.

5. The lithium battery as claimed in claim 4, wherein the host material has a chemical formula of
xLi[Li_{1/3}Mn_{2/3}]O₂-(1−x)Li[Ni_{α-α′}Co_{β-β′}Mn_{γ-γ′}M_{(α′+β′+γ′+δ)}]O_{2+[(α′+β′+γ′+δ)*v/2]},
wherein 0<x<1;
0.3≦α≦0.8;
0.1≦β≦0.4;
0.1≦γ≦0.4;
0≦α′≦0.2;
0≦β′≦0.2;
0≦γ′≦0.2;
0≦δ≦0.2;
0<α′+β′+γ′+δ≦0.2;
α+β+γ=1;
M is Ta, V, Mg, Ce, Fe, Mo, Sb, Ru, Cr, Ti, Zr, or Sn; and
v is a valance number of M.

6. The lithium battery as claimed in claim 4, wherein the doping material occupies the host material with a weight ratio of greater than 0 and less than 10 wt %.

7. The lithium battery as claimed in claim 4, wherein the carbon material comprises carbon powder, graphite, hard carbon, soft carbon, carbon fiber, carbon nanotube, or a combination thereof.

8. The lithium battery as claimed in claim 4, wherein the binder comprises polyvinylidene fluoride, styrene-butadiene rubber, polyamide, or melamine resin.
